(19) United States
(12) Patent Application Publication
(10) Pub. No.: US 2006/0276365 A1
(43) Pub. Date: Dec. 7, 2006

(54) Detergent bar and process for manufacture

(76) Inventors: Subhash Shivshankar Mhatre, Mumbai (IN); Ananthasubramanian Sivakumar, Mumbai (IN)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/551,822

(22) PCT Filed: Mar. 19, 2004
(86) PCT No.: PCT/EP04/03032

§ 371 Date: Oct. 3, 2005

(30) Foreign Application Priority Data
Apr. 3, 2003 (IN) 328/MUM/03

(51) Int. Cl. C11D 17/00

(52) U.S. Cl. 510/294

(57) ABSTRACT

A process for the manufacture of aerated solid shaped detergent compositions comprising the steps of: i) preparation of a melt of the detergent composition to be cast; ii) addition of fatty alcohol to the melt either prior to or after the air or gas has been incorporated into the melt; iii) mixing the melt in a high shear mixer; iv) pouring the melt into a mould; v) cooling the mould; vi) demoulding the solidified-shaped article. Preferably, the detergent composition comprises 20% to 60% by weight of detergent active, 0.1% to 10% by weight fatty alcohol and 30% to 60% by weight water and/or polyhydric alcohol.

The present invention relates to aerated low density cast detergent bars. The invention particularly relates to a process for preparing aerated low density cast detergent bars, wherein the air has been stabilised in the formulation which would aid in producing low density bars, without affecting their user properties.

Soap or non-soap detergent articles are traditionally produced by shear working/homogenisation of the formulation followed by extrusion and stamping. This procedure is only suitable for detergent bar formulations which are thermoplastic, or which are not shear sensitive. The formulations that are shear sensitive are generally produced by the process of casting. In the manufacture of detergent compositions by casting, the formulated system is taken to a fluid state by raising the temperature, filled into moulds, and cooled.

The water content in the detergent bars is generally maintained around 5% to 40%. If gases such as air can be entrapped in the detergent bar, the bulk density of the bar can be reduced, and it enables the manufacture of larger size bars for a given weight. It is also possible to entrap sufficient air in order to make the bars float in the washing solution. The concept of entrapment of air or gas has been achieved more particularly for soap bars, as it is an advantage to have the bars float in the bath tub. The entrapment of air or gas into the soap bar also improves the in-use properties such as feel, lather etc.

U.S. Pat. No. 2,295,594 (P&G, 1942) discloses a process for obtaining floating soap comprising mechanical air entrapment through whipping and extrusion of soap in a condition of pasty cohesiveness such that air in finely divided bubble form can be incorporated. The bars are allowed to cool and harden after extrusion. The soap bar compositions do not contain any non-soap detergent active.

U.S. Pat. No. 5,972,860 (Kao Corporation, 1999), discloses a framed aerated detergent bar essentially incorporating inorganic salts and non-ionic surfactants and a process for the production of such bars wherein air in the form of fine bubbles is whipped into the formulation ensuring that the bubbles are stabilised.

U.S. Pat. No. 5,017,302 (Colgate-Palmolive, 1991) discloses that addition of a straight chain primary alcohol which has 16-18 carbon atoms in the molecule to a bar soap greatly reduces the tendency of the bar to crack during continuous cycle of wetting and drying out. This prior art however, does not teach stabilisation of air in the formulation.

U.S. Pat. No. 6,114,291 (Lever Brothers, 2000) discloses a cast melt skin cleansing bar composition in which low molecular weight polyalkylene glycols are used to provide consumer-desired sensory profiles. It is mentioned that optionally higher alcohols such as lauryl, cetyl, stearyl, oleyl, behenyl, cholesterol and 2-hexydecanol alcohol may be used as preferred emollients in the formulation.

U.S. Pat. No. 5,194,172 (P&G, 1990), U.S. Pat. No. 5,219,487 (P&G, 1992) disclose an aerated freezer bar compositions and process for making the same.

The prior art generally teaches compositions and manufacture of aerated soap bars wherein air entrapment in fine bubble form prior to rigidification and shaping of the product is essential. When the viscosity of the formulation is high then there is a limitation on the amount of air that can be entrapped in the formulation, and it may require special equipment to provide mechanical agitation for whipping air into the formulation. In the converse situation, if the viscosity of the formulation is maintained low, then the stabilisation of the entrapped air becomes a problem. Hence, formulating detergent bars with ultra low density poses a problem.

It has now been possible to obtain ultra low density cast bars by using fatty alcohols to stabilise the air in the formulation.

It thus has been the basic objective of the invention to be able to provide a process for the manufacture of a low density detergent bar composition.

Another object of the present invention is directed to being able to provide a process for the manufacture of a low-density detergent bar composition by incorporating air into the formulation during processing.

Yet further object of the present invention is directed to a process for the manufacture of a low density detergent bar composition by incorporating air and stabilising it in the formulation during processing, but maintaining the physical and in use properties of the bar.

According to a firs aspect of the present invention there is provided a process for the manufacture of an aerated solid shaped detergent composition comprising:
i. 20% to 60% by wt. of detergent active
ii. up to 10% by wt. fatty alcohol
iii. 30% to 60% wt water and/or polyhydric alcohol
   which process comprises the steps of:
i. preparation of a melt of the detergent composition to be cast;
ii. addition of fatty alcohol prior to or after incorporation of air or gas into the said melt;
iii. mixing the melt in a high shear mixer;
iv. pouring the said melt into a mould;
v. cooling the mould to promote solidification of the composition; and
vi. demoulding the solidified-shaped article.

According to a preferred aspect of the invention there is provided a process for the manufacture of an aerated solid shaped detergent composition comprising:
i. 20% to 60% by wt. of soap,
ii. 0 to 30% by wt. non-soap detergent active,
iii. 0.1% to 9% by wt. fatty alcohol,
iv. 30% to 60% wt water and/or polyhydric alcohol, which process comprises the steps of:
i. preparation of a melt of the detergent composition to be cast;
ii. addition of fatty alcohol prior to or after incorporation of air or gas into the said melt;
iii. mixing the melt in a high shear mixer;
iv. pouring the said melt into a mould;
v. cooling the mould to promote solidification of the composition; and
vi. demoulding the solidified-shaped article.

It is particularly preferred that the addition of the fatty alcohol is done after the incorporation of air or gas.

It is an essential part of the process that 0.1% to 10% of one or more fatty alcohols are incorporated into the formulation either prior to or after the incorporation of air, which helps in stabilising of the air in the product. The process is particularly but not exclusively suitable for manufacturing shaped detergent articles such as soap tablets for personal wash.

The detergent active used in the process may be soap or non-soap surfactants. The detergent active is preferably an anionic surfactant. The detergent active may be generated by neutralising the acid precursor of the active with an alkali, or pre-formed active may be used. The detergent active is mixed with water and or other solvents and heated to form a melt. Any suitable composition that can be converted into a melt at elevated temperatures may also be employed in the process.

The term total fatty matter, usually abbreviated to TFM is used to denote the percentage by weight of fatty acid and triglyceride residues present in soaps without taking into account the accompanying cations.

For a soap having 18 carbon atoms, an accompanying sodium cation will generally amount to about 8% by weight. Other cations may be employed as desired, for example zinc, potassium, magnesium, alkyl ammonium and aluminium.

The term soap denotes salts of carboxylic fatty acids. The soap may be derived from any of the triglycerides conventionally used in soap manufacture—consequently the carboxylate anions in the soap may contain from 8 to 22 carbon atoms.

The soap may be obtained by saponifying a fat and/or a fatty acid. The fats or oils generally used in soap manufacture may be such as tallow, tallow stearines, palm oil, palm stearines, soya bean oil, fish oil, caster oil, rice bran oil, sunflower oil, coconut oil, babassu oil, palm kernel oil, and others. In the above process the fatty acids are derived from oils/fats selected from coconut, rice bran, groundnut, tallow, palm, palm kernel, cotton seed, soybean, castor etc. The fatty acid soaps can also be synthetically prepared (e.g. by the oxidation of petroleum or by the hydrogenation of carbon monoxide by the Fischer-Tropsch process). Resin acids, such as those present in tall oil, may be used. Naphthenic acids are also suitable.

Tallow fatty acids can be derived from various animal sources and generally comprise about 1% to 8% myristic acid, about 21% to 32% palmitic acid, about 14% to 31% stearic acid, about 0 to 4% palmitoleic acid, about 36% to 50% oleic acid, and about 0 to 5% linoleic acid. A typical distribution is 2.5% myristic acid, 29% palmitic acid, 23% stearic acid, 2% palmitoleic acid, 41.5% oleic acid, and 3% linoleic acid. Other similar mixtures, such as those from palm oil and those derived from various animal tallow and lard are also included.

Coconut oil refers to fatty acid mixtures having an approximate carbon chain length distribution of 8% C₈, 7% C₁₀, 48% C₁₂, 17% C₁₄, 8% C₁₆, 2% C₁₈, 7% oleic and 2% linoleic acids (the first six fatty acids listed being saturated). Other sources having similar carbon chain length distributions, such as palm kernel oil and babassu kernel oil, are included within the term coconut oil.

A typical suitable fatty acid blend consisted of 5% to 30% coconut fatty acids and 70% to 95% fatty acids, ex hardened rice bran oil. Fatty acids derived from other suitable oils/fats such as groundnut, soybean, tallow, palm, palm kernel, etc. may also be used in other desired proportions.

The composition according to the invention will preferably comprise detergent actives which are generally chosen from anionic, nonionic, cationic, zwitterionic detergent actives or mixtures thereof. Suitable examples of detergent-active compounds are compounds commonly used as surface-active agents given in the well-known textbooks “Surface Active Agents”, Volume I by Schwartz and Perry and “Surface Active Agents and Detergents”, Volume II by Schwartz, Perry and Berch or “Handbook of Surfactants”, M. R. Porter, Blackie Publishers, 1991.

The non-soap detergent active is preferably incorporated at a level of 1% to 10% by weight of the composition.

The fatty alcohol is selected from alcohols that have 8 to 18 carbon atoms in each acyl or alkyl group. It is particularly preferred that the fatty alcohols are selected from cetyl or stearyl alcohols, or a mixture thereof. It is preferred that the fatty alcohols are incorporated in the formulation in the range 1% to 9% by wt. Polyhydric alcohols suitable for use in the invention include poly(ethylene glycol), propylene glycol, glycerol and sorbitol. Especially preferred is a mixture of PEG, Propylene glycol and sorbitol. The polyhydric alcohol is suitably added a) before saponification or b) before and after saponification.

Poly(ethylene glycol) used in the invention preferably has a molecular weight of from 200 to 1500.

The polyhydric alcohol is present in an amount of from 20% to 50%, more preferably from 20% to 45%, and most preferably from 30% to 40% by weight of the total soap bar.

The conventional ingredients used in detergent formulations may suitably be incorporated in the formulation. Some of the ingredients are listed below.

The detergency builders suitable for use in the formulation are preferably inorganic and suitable builders include, for example, alkali metal aluminosilicates (zeolites), alkali metal carbonate, sodium tripolyphosphate (STPP), tetrasodium pyrophosphate (TSPP), citrates, sodium nitrilotriacetate (NTA) and combinations of these. Builders are typically used in an amount ranging from 1% to 30% by wt.

Suitable examples of benefit agents include moisturisers and humectants, include Carbopol 934, ethoxylated castor oil, paraffin oils, lanolin and its derivatives. Silicone compounds such as silicone surfactants like DC3225C (Dow Corning) and/or silicone emollients, silicone oil (DC-200 Ex-Dow Corning) may also be included. Sun-screens such as 4-tertiary butyl-4′-methoxy dibenzoylmethane (available under the trade name PARSOL 1789 from Givaudan) and/or 2-ethyl hexyl methoxy cinnamate (available under the trade name PARSOL MCX from Givaudan) or other UV-A and UV-B sun-screens may also be included. Water soluble glycols such as propylene glycol, ethylene glycol, glycerol, may be employed at levels up to 10%.

An inorganic particulate phase is not an essential ingredient of the formulation, but may be incorporated especially for hard surface cleaning compositions. Preferably, the particulate phase comprises a particulate structurant and/or abrasive which is insoluble in water. In the alternative, the abrasive may be soluble and present in such excess to any water present in the composition that the solubility of the abrasive in the aqueous phase is exceeded, and consequently solid abrasive exists in the composition.

Suitable inorganic particulates can be selected from particulate zeolites, calcites, dolomites, feldspars, silicas, silicates, other carbonates, bicarbonates, borates, sulphates and polymeric materials such as polyethylene.

The most preferred inorganic particulates are calcium carbonate (as Calcite), mixtures of calcium and magnesium carbonates (as dolomite), sodium hydrogen carbonate, borax, sodium/potassium sulphate, zeolite, feldspars, talc, koalin and silica.

Calcite, talc, kaolin, feldspar and dolomite and mixtures thereof are particularly preferred due to their low cost and colour.

The inorganic particulate structurants such as alumino silicate may be generated in situ using aluminium sulphate and sodium silicate in the formulation. It is also possible to incorporate readily available sodium alumino-silicate into the formulation.

Other additives such as one or more water insoluble particulate materials such as talc, kaolin, polysaccharides such as starch or modified starches and celluloses may be incorporated into the formulations.

In step (b) of the process, minor and conventional ingredients preferably selected from enzymes, antiredeposition agents, fluorescers, colour, preservatives and perfumes, also bleaches, bleach precursors, bleach stabilisers, sequestrants, soil release agents (usually polymers) and other polymers may optionally be incorporated at levels up to 10 wt %.

With regard to the process according to the invention, the detergent active is preferably generated either by neutralising the acid precursor of the detergent active, or by using readily available detergent actives. The detergent active along with other ingredients that form the composition of the bar is converted into an isotropic solution by raising the temperature. Air or gas is incorporated into the composition before pouring it into a mould. The mould is cooled suitably to bring about rigidification of the composition. The solidified composition is demoulded and if required cut into tablets.

The process of the invention will now be described with reference to a comparative example of a conventional process, as well as a non-limiting example of a process according to the invention.

### EXAMPLES

### Example 1

### Process of Manufacture of an Aerated Bar

The formulation for a 1 kilogram batch is tabulated in Table 1.

TABLE 1

| Ingredients | Weight (grams) |
|---|---|
| Fatty acid | 348 |
| NaOH (50% solution) | 123 |
| Polyol (some are aqueous solutions) | 367 |
| sodium lauryl sulphate (SLS) | 70 |
| Water | 30 |
| Other | 32 |
| Cetyl alcohol | 30 |
| Total | 1000 |

Initially fatty acid was charged along with part of the polyol mixture into the reactor and was melted at 70-80° C. After the fat charge was melted, it was neutralised using sodium hydroxide at 85-90° C. After neutralisation, the minor ingredients such as preservatives etc were added. The rest of the polyol mixture was then added. Finally, sodium lauryl sulphate and water were added, and the melt was mixed until the SLS is dissolved. The melt was then transferred to another vessel and was mixed under high shear using a Silverson mixer. While mixing, air was passed at a fixed flow rate into the melt for a period of 20 minutes. After aeration, cetyl alcohol was added to the melt and mixed. The aerated melt was then poured into a mold. Upon solidification, the bar was demolded.

### Example II

### Stabilisation of Air in the Composition

The different formulations as described in Table 2 and 4 were analysed for processing parameters and various physical and in use properties of the bar by the procedures described below.

Determination of Density

The density of the soap was measured by weighing a piece in air and in water. The ratio of the weight in air to weight in water is the density of the soap.

Determination of Hardness

The hardness of the soap bar was rated based on the feel of the bar and given a rating of very soft, soft, good and excellent, and was correlated with hardness measured using the penetration test, where the penetration of a sharp rod in the soap bar under known weight is determined.

Determination of In-Use Properties

The in-use properties in terms of feel and lather were determined through sensory perception, and were rated as okay, good, very good and excellent.

TABLE 2
Effect of different levels of cetyl alcohol on
stabilisation of air.

| | Ex 1 | Ex 2 | Ex 3 | Ex 4 |
|---|---|---|---|---|
| Composition | | | | |
| (% wt.) | | | | |
| Soap | 37.5 | 37.5 | 37.5 | 37.5 |
| Polyhydric alcohol | 31.5 | 33.5 | 31.5 | 33.5 |
| Na lauryl sulfate | 7 | 7 | 7 | 7 |
| Water | 18 | 18 | 16 | 19 |
| Other | 3 | 3 | 3 | 3 |
| Cetyl alcohol | 3 | 1 | 5 | — |
| Product | | | | |
| Characteristics | | | | |
| Melt pourability | good | very good | good | excellent |
| Density | 0.66 | 0.73 | 0.87 | 1.1 |
| | | | | (air creams up |
| | | | | to the top) |
| Hardness | good | good | good | excellent |
| | | | | (unaerated) |
| In use properties | excellent | excellent | excellent | good |

The data presented in Table 2 show that when cetyl alcohol was added to the detergent bars prepared according to the process of the invention, the air incorporated in the bar was stabilised, and the bars also exhibit excellent in-use properties. In the control bars where no cetyl alcohol was added the air creams up, and no reduction in density could be achieved. The bars according to the invention were uniform and had a smooth finish.

TABLE 3
Effect of incorporation of cetyl alcohol at levels
beyond the invention

| | Ex 4 | Ex 5 | Ex 6 |
|---|---|---|---|
| Composition (% wt.) | | | |
| Soap | 28 | 28 | 28 |
| Polyhydric alcohol | 47 | 43 | 47 |
| Na lauryl sulfate | 5.5 | 5.5 | 5.5 |
| Water | 13.5 | 10.5 | 13.5 |
| Other | 3 | 3 | 6 |
| Cetyl alcohol | 3 | 10 | — |
| Product | | | |
| Characteristics | | | |
| Melt pourability | very good | not | Excellent |
| | | pourable | |
| Density | 0.69 | — | 1.1 |
| | | | (air creams up |
| | | | to the top) |
| Hardness | good | — | Excellent |
| | | | (unaerated) |
| In use properties | excellent | — | Good |

The data presented in Table 3 show that when cetyl alcohol was added at 10% the melt becomes non pourable and hence lead to problems in casting of the detergent bars. The addition and the level of the stabilising agent, cetyl alcohol was critical as demonstrated by the examples presented in the tables above. Without the stabilisation, the air bubbles cream to the top.

### Example III

### Selection of the Stablising Agents

Detergent bars were prepared by using cetyl alcohol as the stabilising agent in Example 7, polyvinyl alcohol as the stabilising agent in Example 8 and in Example 9 with no stabilising agent. The bars thus prepared were tested for the stabilisation of air and also other physical and in use properties by the procedure mentioned above and the data are presented in Table 4.

TABLE 4
Effect of the nature of the stabilising agent

| | Ex 7 | Ex 8 | Ex 9 |
|---|---|---|---|
| Composition (% wt.) | | | |
| Soap | 37.5 | 37.5 | 37.5 |
| Polyhydric alcohol | 33.5 | 33.5 | 33.5 |
| Na lauryl sulfate | 7 | 7 | 7 |
| Water | 18 | 18 | 19 |
| Other | 3 | 3 | 3 |
| Cetyl alcohol | 1 | — | — |
| Poly vinyl alcohol | — | 1 | — |
| Product | | | |
| Characteristics | | | |
| Melt pourability | good | good | excellent |
| Density | 0.66 | 1.1 | 1.1 |
| | | (air creams up | (air creams up |
| | | to the top) | to the top) |
| Hardness | good | excellent | excellent |
| | | (unaerated) | (unaerated) |
| In use properties | excellent | good | good |

The selection of stabilising agent is critical. In experiments where cetyl alcohol was added, the bars showed good aeration and other properties. Other stabilising agents that work through increasing the melt viscosity such as polyvinyl alcohol, were not successful in stabilising the air bubbles in the melt.

### Example IV

### Effect of Sequence of Addition of Cetyl Alcohol and Incorporation of Air

In separate experiments, cetyl alcohol was added before aeration and after aeration. In both the cases, the aeration was good and the bars had uniform distribution of the air bubbles. The physical and in use properties were also comparable.

It is thus possible by way of present invention to provide for a simple process by which low density aerated detergent bars can be manufactured while ensuring that the air or gas that has been incorporated in the formulation is stabilised in the product.

1. A process for the manufacture of aerated solid shaped detergent compositions comprising the steps of:
i) preparation of a melt of the detergent composition to be cast;
ii) addition of 0.1% to 10% fatty alcohol to the melt either prior to or after the air or gas has been incorporated into the melt;
iii) mixing the melt in a high shear mixer;
iv) pouring the melt into a mould;
v) cooling the mould;
vi) demoulding the solidified-shaped article.

2. The process of claim 1 wherein the detergent composition comprises:
a) 20% to 60% by weight of detergent active;
b) 0.1% to 10% by weight fatty alcohol;
c) 30% to 60% by weight water and/or polyhydric alcohol.

3. The process of claim 2 wherein the detergent active is soap.

4. The process of claim 1 wherein the composition additionally comprises 1% to 10% by weight non-soap detergent active.

5. The process of claim 1 wherein the fatty alcohol comprises 1% to 9% by weight.

6. The process of claim 2 wherein the polyhydric alcohol is a mixture of polyethylene glycol with a molecular weight of between 200 and 1500, propylene glycol and sorbitol.

7. The process of claim 2 wherein the polyhydric alcohol comprises 20% to 50% by weight.

8. The process of claim 1 wherein the soap is formed by saponification.

9. The process of claim 8 wherein the polyhydric alcohol is added before saponification.

10. The process of claim 8 wherein the polyhydric alcohol is added both before and after saponification.

11. The process of claim 1 wherein the fatty alcohol comprises 8 to 18 carbon atoms in each acyl or alkyl group.

12. The process of claim 1 wherein the fatty alcohol is selected from cetyl or stearyl alcohols, or mixtures thereof.

13. The process of claim 2 wherein the aerated solid shaped detergent composition comprises a soap tablet.
